(19) United States
(12) Patent Application Publication
(10) Pub. No.: US 2014/0175013 A1
(43) Pub. Date: Jun. 26, 2014

(54) NANOFILTRATION MEMBRANE

(71) Applicants: Martin Mechelhoff, Cologne (DE); Thomas Fruh, Wuppertal (DE); Christopher Kohl, Mainz (DE)

(72) Inventors: Martin Mechelhoff, Cologne (DE); Thomas Fruh, Wuppertal (DE); Christopher Kohl, Mainz (DE)

(73) Assignee: LANXESS Deutschland GmbH, Cologne (DE)

(21) Appl. No.: 13/984,576

(22) PCT Filed: Feb. 9, 2012
(86) PCT No.: PCT/EP2012/052165

§ 371 Date: Jan. 14, 2014

(30) Foreign Application Priority Data
Feb. 10, 2011 (EP) 11153944.1

(51) Int. Cl. B01D 71/82; B01D 61/02; B01D 69/12

(52) U.S. Cl. CPC B01D 71/82; B01D 69/12; B01D 61/027; B01D 69/125
USPC 210/650; 210/490; 524/558

(57) ABSTRACT

The invention relates to a nanofiltration membrane having a porous support membrane, the surface of the support membrane being coated with polymer particles which are prepared by emulsion polymerization and which have an average particle diameter of less than 70 nm, preferably between 30-60 nm, more preferably between 40-50 nm.

The invention relates to nanofiltration membranes having a porous support membrane, to a process for producing this membrane, and to the use thereof.

In the chemical industry, food industry, beverage industry, electronics industry and pharmaceutical industry, use is made, for example, of membranes for the separation of solid/liquid mixtures and liquids. In the context of environmental technology, these membranes are also used in the purification of waste waters and the production of drinking water.

A variety of membrane separation techniques are known from the prior art. They include microfiltration, ultrafiltration and nanofiltration, and also reverse osmosis. These techniques can be classed as mechanical separation processes. The separation mechanisms are governed by different membrane structures. These structures carry out separation by means of membrane pores whose diameter is smaller than that of the particles to be separated off.

Another key mechanism in separation using nanofiltration membranes and reverse osmosis membranes, in addition to steric effects, are the electrostatic interaction of ions in solution or of partly dissociated hydrocarbons with corresponding charged groups on the surface of a membrane in aqueous solution. This interaction allows separation of two substances having a similarly sized particle radius but differing in charge or functionality, respectively. Similarly, separation in the case of membranes with correspondingly small pores, such as for nanofiltration or reverse osmosis, for example, may be based on the differences in tendency of the substances present in a solution to diffuse through the membrane on permeation.

Known processes for the treatment of liquids under pressure are microfiltration, ultrafiltration and nanofiltration. The pore size of the nano-, ultra- and micro-filtration membranes are approximately 0.001 μm to 10.0 μm.

For characterizing membranes it is usual to employ the retention R in respect of a substance.

$$R = \frac{w ( feed ) - w ( permeate )}{w ( feed )} \times 100 [ \% ]$$

where w is the mass fraction of a particular substance.

The retention describes the percentage fraction of a separated substance in the permeate (from Latin “permeare”=to pass through), relative to the concentration in the feed. It is dependent not only on the temperature but also on the trans-membrane pressure or flow rate and the concentration of the starting solution. The retentate (from Latin, “retenere”=to hold back) constitutes the concentration of the substance to be separated, this concentration being increased in comparison to the feed.

This shows the difficulty when assessing the separating properties of a membrane. A rough classification of the membranes is often given by the molecular cut-off together with the flow rate. This cut-off is synonymous with the molar mass for which the membrane has a retention of at least 90%, and may be very different, particularly in the nanofiltration range, depending on the molecular construction of the substances to be separated. The cut-off of nanofiltration membranes is typically <1500 g/mol. Ultrafiltration membranes typically have a cut-off of <about 150 000 g/mol.

Likewise known are membranes based on organic polymers, which are used for separations at molecular level, such as the separation of gases, for example, and also pervaporation and/or vapour permeation. A disadvantage of these polymer membranes, however, is their short lifetime, owing to the sensitivity of the polymer membranes with respect to solvents, which destroy the membrane material or cause it to swell. Furthermore, the relatively low temperature resistance of the common polymer membranes represents a problem.

Use is also made frequently of ceramic membranes, which have a considerably greater lifetime, since, according to their composition, they are very largely inert towards organic compounds, acids or alkalis and, furthermore, they have a higher temperature resistance than polymer materials. Accordingly, they can also be used for separation tasks in chemical operations, such as in vapour permeation, for example. Ceramic membranes of these kinds are typically produced by the sol-gel method or by the dip-coating method, in such away as to produce, overall, a multi-layered system of ceramic layers with different thicknesses and pore sizes, with the topmost layer, the layer which takes on the actual separation task, possessing the smallest pores and being constructed no as to be as thin as possible. As a result of the low elasticity of ceramic materials, ceramic membranes are sensitive to mechanical load, and break easily. In contrast to polymer membranes, they cannot be rolled in order to produce space-saving wound modules.

Generally it can be stated that, for all known membrane synthesis methods, a principal problem is to control the setting of the pore size and the pore shape of the separation-active layer in a precise and uniform way, and hence to achieve a very narrow pore size distribution.

Polymeric membranes made of a very wide variety of polymers are available at relatively favourable cost, for wide pH ranges and numerous applications, but in the majority of cases lack resistance to organic solvents, and also lack resistance at very high and/or very low pH levels. Moreover, durable temperature stability at above 80° C. is seldom a feature. Although there have been many approaches aimed at improving these properties of polymer membranes, it is often the case that one of the above requirements is not met. Moreover, at relatively high temperatures, the majority of polymers are plastically deformable. This results in a compacting of the membranes as a whole when they are operated under pressure at relatively high temperatures. The compacting causes the pore microstructure of a membrane to be completely compressed, thereby producing a sharp increase in the resistance to filtration. A drop-off in flow is thereby induced. Another disadvantage of the customary polymer materials is the poor resistance towards organic solvents or oils, and the plasticizing effect of the oils on the polymers. This adversely affects the separation capacity of the membranes.

Membrane technology plays an important part in the purification of mixtures of liquids. In the recovery of drinking water from salt water by means of reverse osmosis, and in the working-up of products, in particular, ultrafiltration and nanofiltration techniques, and reverse osmosis membranes, are in increasing use.

Generally speaking, in membrane processes, dilute solutions are concentrated and organic solvents, water solutions or salt solutions are separated off. Here, either compounds of value or pollutant compounds are obtained, in concentrated and possibly lower-salt-content solutions, making subsequent storage, transport, disposal and further processing more cost-effective. In waste water treatment, in particular, the aim of the membrane treatment is to recover the greatest part of the volume as a permeate in an unpolluted or only slightly polluted form. The concentrated retentate can be worked up in terms of remanent compounds of value, with lesser cost and effort, or can be disposed of more cost-effectively in this concentrated form, such as by incineration, for example.

The field of the membrane techniques encompasses a very wide variety of different processes. Consequently there are also different membranes and different technical designs of such membranes. Technically relevant membrane separation techniques are operated primarily as cross-flow filtrations. High shear rates, as a result of high flow rates and specific module constructions, are intended to minimize membrane fouling and reduce concentration polarization.

Commercially available nanofiltration membranes are composite membranes prepared by means of phase interface condensation, as described in U.S. Pat. No. 5,049,167, for example. These known membranes, however, are very costly and inconvenient to produce, being producible only with safety measures that have cost implications, since carcinogenic diamines and highly reactive acryloyl chlorides are examples of reactants used. Membranes of this kind may have a diversity of configurations, in the form, for example, of flat film modules, cassette modules, spiral-wound modules or hollow-fibre modules.

Furthermore, commercial filtration membranes can usually be used only at process temperatures of up to about 80° C.

It is an object of the present invention, therefore to provide a high-performance nanofiltration membrane which exhibits a high thermal load-bearing capacity, good stability in organic and inorganic solvents and also at high and low pH levels, and, moreover, good separation properties on the basis of a suitable surface modification. A further object of the invention is the provision of a method with which it is possible to produce defined pore sizes for the membranes in question.

From the prior art it is known that polymer particles can be deposited on a porous substrate which possesses a relatively broad pore size distribution, in order to obtain a composite membrane having a relatively narrow pore size distribution. The cavities between the particles form pores with which separation can be carried out from a liquid. The composite membranes obtained in this way can be used as ultrafiltration and microfiltration membranes, for example.

For achievement of the object, therefore, a nanofiltration membrane of the type specified at the outset is provided, where the surface of the support membrane is coated with polymer particles which are prepared by emulsion polymerization and which have an average particle diameter <70 nm, preferably between 30 to 65 nm, more preferably between 40 to 50 nm.

A distinction is made here between the filtration quality of a membrane, characterized by the cut-off, for example, and the construction of the filtration membrane.

References below to nanofiltration membranes are to the use of polymer particles in the particle diameter range ≦100 nm for producing such membranes. The term “nanofiltration membrane” does not have any implication for its separation properties.

Separation effect, separation properties and separation behaviour are used as synonyms. The separation effect is defined by means of the aforementioned cut-off.

Polymer particles and nanoparticles are used here as synonyms.

The use of polymer particles which are prepared by emulsion polymerization and which have an average particle diameter <70 nm, preferably between 30 to 65 nm, more preferably between 40 and 50 nm, offers numerous advantages over other polymer particles, since the chemical and physical properties of the polymer particles, such as particle size, particle morphology, swelling behaviour, catalysis activity, hardness, dimensional stability, stickiness, surface energy, ageing resistance and impact toughness, can be adjusted. This is accomplished on the one hand by the production method, more particularly by the polymerization process, and also by the selection of suitable base monomers, and on the other hand through the selection of suitable functional groups, the concentration and occupancy range of which in the polymer particle can be customized or tailored within wide limits.

The separation-active layer is therefore the layer produced with polymer particles which are prepared by emulsion polymerization and which have an average particle diameter <70 nm, preferably between 30 to 65 nm, more preferably between 40 to 50 nm, also referred to as the polymer layer, of the nanofiltration membrane of the invention.

By emulsion polymerization is meant more particularly a process which is known per se and in which the reaction medium used is usually water, in which the monomers used are polymerized in the absence or presence of emulsifiers and radical-forming substances, with formation of usually aqueous polymer latices (see inter alia Römpp Lexikon der Chemie, Volume 2, 10^{th} Edition, 1997; P. A. Lovell, M. S. El-Aasser, Emulsion Polymerization and Emulsion Polymers, John Wiley & Sons, ISBN: 0 471 96746 7; H. Gerrens, Fortschr. Hochpolym. Forsch. 1, 234 (1959)). Unlike suspension polymerization or dispersion polymerization, emulsion polymerization generally yields relatively fine particles, which allow a smaller interstitial diameter and hence smaller pore sizes in the separation-active layer. Particles with a size of below 500 nm are generally not obtainable by suspension polymerization or dispersion polymerization, and so these particles are generally unsuitable for the purposes of this patent application.

Surprisingly it has now been found that, as a result of the selection of defined polymer particles, there is no longer any need to use additional thermal or chemical means to stabilize the nanofiltration membrane of the invention.

The choice of monomers is used to adjust the glass transition temperature and the breadth of the glass transition of the polymer particles. The glass transition temperature (Tg) and the breadth of the glass transition (ΔTg) of the polymer particles are determined by means of differential scanning calorimetry (DSC), preferably as described below. For this determination of Tg and ΔTg, two cooling/heating cycles are carried out. Tg and ΔTg are determined in the second heating cycle. The determinations use about 10-12 mg of the selected polymer particle in a DSC sample holder (standard aluminium boat) from Perkin-Elmer. The first DSC cycle is carried out by first cooling the sample to −100° C. with liquid nitrogen, and then heating it at a rate of 20 K/min to +150° C. The second DSC cycle is commenced by immediate cooling of the sample as soon as a sample temperature of +150° C. has been reached. In the second heating cycle, the sample is heated up to +150° C. again as in the first cycle. The heating rate in the second cycle is again 20 K/min. Tg and ΔTg are determined graphically from the DSC curve of the second heating process. For this purpose, three straight lines are placed on the DSC curve. The 1^{st} line is placed on the part of the DSC curve below Tg, the second line on the branch of the curve that passes through Tg, with the point of inflection, and the third line on the branch of the DSC curve above Tg. In this way, three straight lines with two points of intersection are obtained. Each of these two points of intersection is marked by a characteristic temperature. The glass transition temperature Tg is obtained as the average value of these two temperatures, and the breadth of the glass transition. ΔTg, is obtained from the difference between the two temperatures.

The polymer particles preferably have a glass transition temperature (Tg) of −85° C. to 150° C., more preferably −75° C. to 110° C., very preferably −70° C. to 90° C.

The breadth of the glass transition for the polymer particles used in accordance with the invention is preferably greater than 5° C., more preferably greater than 10° C.

The polymer particles prepared by emulsion polymerization are preferably rubber-like.

Rubber-like polymer particles are preferably those based on conjugated dienes such as, for example, butadiene, isoprene, 2-chlorobutadiene and 2,3-dichlorobutadiene, vinyl acetate, styrene or derivatives thereof, 2-vinylpyridine and 4-vinylpyridine, acrylonitrile, acrylamides, methacrylamides, tetrafluoroethylene, vinylidene fluoride, hexafluoropropene, and double-bond-containing hydroxyl, epoxy, amino, carbonyl and keto compounds.

Preferred monomers or monomer combinations include the following: butadiene, isoprene, acrylonitrile, styrene, alpha-methylstyrene, chloroprene, 2,3-dichlorobutadiene, butyl acrylate, 2-ethylhexyl acrylate, hydroxyethyl methacrylate, slycidyl methacrylate, acrylic acid, diacetoneacrylamide, tetrafluoroethylene, vinylidene fluoride and hexafluoropropene.

“Based on” here means that the polymer particles consist preferably to an extent of more than 60%, more preferably more than 70%, very preferably more than 90%, by weight of the stated monomers.

The polymer particles may be crosslinked or non-crosslinked. The polymer particles may more particularly be particles based on homopolymers or random copolymers. The terms homopolymers and random copolymers are known to the skilled person and explain for example in Vollmert, Polymer Chemistry, Springer 1973.

Serving as the polymer basis for the rubber-like crosslinked or non-crosslinked polymer particles comprising functional groups may be, more particularly, the following:
BR: polybutadiene,
ABR: butadiene/acrylic acid C₁₋₄alkyl ester copolymers,
IR: polyisoprene,
SBR: random styrene-butadiene copolymers having styrene contents of 1-60, preferably 5-50 percent by weight,
FKM: fluorinated rubber,
ACM: acrylate rubber,
NBR: polybutadiene-acrylonitrile copolymers having acrylonitrile contents of 5-60, preferably 10-60 percent by weight,
CR: polychloroprene
EAM: ethylene/acrylate copolymers,
EVM: ethylene/vinyl acetate copolymers.

Other preferred polymer particles are thermoplastic and are based on methacrylates, more particularly methyl methacrylate, styrene, alpha-methylstyrene and acrylonitrile.

The polymer particles preferably have an approximately spherical geometry.

The polymer particles used in accordance with the invention have an average particle diameter of less than 70 nm, preferably between 30 to 65 nm, more preferably between 40 to 50 nm.

The average particle diameter is determined by means of ultracentrifugation with the aqueous latex of the polymer particles from the emulsion polymerization. The method yields an average value for the particle diameter that takes account of any agglomerates (H. G. Müller (1996) Colloid Polymer Science 267: 1113-1116, and W. Scholtan, H. Lange (1972) Kolloid-Z u. Z. Polymere 250: 782). The ultracentrifugation has the advantage that the entire particle size distribution is characterized, and different averages, such as numerical average and weight average, can be calculated from the distribution curve. The average diameter figures used in accordance with the invention refer to the weight average. It is possible to use diameter figures such as d₁₀, d₅₀ and d₈₀. These figures mean that 10%, 50% and 80%, respectively, by weight of the particles possess a diameter which is smaller than the corresponding numerical value in % by weight.

The diameter determination by means of dynamic light scattering is carried out on the latex. Customary lasers are those which operate at 633 nm (red) and at 532 nm (green). The dynamic light scattering produces an average value for the particle size distribution curve. The average diameter figures used in accordance with the invention relate to this average value.

The particles are prepared by emulsion polymerization, with the particle size being adjusted within a wide diameter range by varying the reactants and also emulsifier concentration, initiator concentration, liquor ratio of organic phase to aqueous phase, ratio of hydrophilic to hydrophobic monomers, amount of crosslinking monomer, polymerization temperature, etc.

After the polymerization, the latices are treated by vacuum distillation or by stripping with superheated steam in order to remove volatile components, more particularly unreacted monomers.

There is no need for any further work-up of the polymer particles prepared, through coagulation methods, for example.

The polymer particles which are prepared by emulsion polymerization and which are used in accordance with the invention are, in one preferred embodiment, at least partly crosslinked.

The crosslinking of the polymer particles which are prepared by emulsion polymerization is accomplished preferably by the addition of polyfunctional monomers in the polymerization, such as, for example, through the addition of compounds having at least two, preferably 2 to 4, copolymerizable C═C double bonds, such as diisopropenylbenzene, divinylbenzene, divinyl ether, divinyl sulphone, diallyl phthalate, triallyl cyanurate, triallyl isocyanurate, 1,2-polybutadiene, N,N′-m-phenylenemaleimide, 2,4-tolylenebis(maleimide), triallyl trimellitate, glycidyl methacrylate, acrylates and methacrylates of polyhydric, preferably 2- to 4-hydric, C2 to C10 alcohols, such as ethylene glycol, propane-1,2-diol, butanediol, hexanediol, polyethylene glycol with 2 to 20, preferably 2 to 8, oxyethylene units, neopentyl glycol, bisphenol A, glycerol, trimethylolpropane, pentaerythritol, sorbitol and also unsaturated polyesters of aliphatic diols and polyols and maleic acid, fumaric acid, and/or itaconic acid.

The polymer particles may be crosslinked directly during the emulsion polymerization, such as by copolymerization with polyfunctional compounds that have a crosslinking activity, or by subsequent crosslinking as described below. Direct crosslinking during the emulsion polymerization is preferred. Preferred polyfunctional comonomers are compounds having at least two, preferably 2 to 4, copolymerizable C═C double bonds, such as diisopropenylbenzene, divinylbenzene, divinyl ether, divinyl sulphone, diallyl phthalate, triallyl cyanurate, triallyl isocyanurate, 1,2-polybutadiene. N,N′-m-phenylenemaleimide, 2,4-tolylenebis(maleimide) and/or triallyl trimellitate. Additionally contemplated are the acrylates and methacrylates of aliphatic amines, epoxides and polyhydric preferably 2- to 4-hydric, C2 to C10 alcohols, such as ethylene glycol, propane-1,2-diol, butanediol, hexanediol, polyethylene glycol with 2 to 20, preferably 2 to 8, oxyethylene units, neopentyl glycol, bisphenol A, glycerol, trimethylolpropane, pentaerythritol, sorbitol and also unsaturated polyesters of aliphatic diols and polyols and maleic acid, fumaric acid, and/or itaconic acid.

The crosslinking during the emulsion polymerization may also take place by continuing the polymerization through to high conversions or, in the monomer feed process, by polymerization with high internal conversions. An alternative possibility is to carry out the emulsion polymerization in the absence of chain-transfer regulators.

For the crosslinking of the non-crosslinked or only slightly crosslinked polymer particles following the emulsion polymerization, it is best to use the latices which are obtained in the emulsion polymerization.

Examples of suitable chemicals having crosslinking activity include organic peroxides, such as dicumyl peroxide, tert-butyl cumyl peroxide, bis(tert-butylperoxyisopropyl)benzene, di-tert-butyl peroxide, 2,5-dimethylhexane 2,5-dihydroperoxide, 2,5-dimethylhex-3-yne 2,5-dihydroperoxide, dibenzoyl peroxide, bis(2,4-dichlorobenzoy)) peroxide, tert-butyl perbenzoate, and also organic azo compounds, such as azobisisobutyronitrile and azobiscyclohexane nitrile and also dimercapto and polymercapto compounds, such as dimercaptoethane, 1,6-dimercaptohexane, 1,3,5-trimercaptotriazine and mercapto-terminated polysulphide rubbers such as mercapto-terminated reaction products of bischloroethylformal with sodium polysulphide.

The optimum temperature for carrying out the post-crosslinking is of course dependent on the reactivity of the crosslinker and may optionally be carried out under elevated pressure at temperatures from room temperature up to about 180° C. (in this regard, see Houben-Weyl, Methoden der organischen Chemie, 4^{th} Edition, Volume 14/2, page 848). Particularly preferred crosslinking agents are peroxides.

The crosslinking of rubbers containing C═C double bonds to form polymer particles may also take place in dispersion or in emulsion with simultaneous, partial, optionally complete hydrogenation of the C═C double bond by hydrazine as described in U.S. Pat. No. 5,302,696 or U.S. Pat. No. 5,442,009, or, optionally, other hydrogenating agents, examples being organometal hydride complexes,

Before, during or after the post-crosslinking it is possible, optionally, to carry out particle enlargement by agglomeration.

The crosslinked polymer particles used in accordance with the invention advantageously have fractions insoluble in toluene at 23° C. (gel content) of at least about 70% by weight, more preferably at least about 80% by weight, more preferably 90% by weight, even more preferably at least about 98% by weight. This toluene-insoluble fraction is determined in toluene at 23°. In this determination, 250 mg of the polymer particles are swollen in 25 ml of toluene with shaking at 23° C. for 24 hours. Following centrifugation at 20 000 rpm, the insoluble fraction is separated off and dried. The gel content is given by the ratio of the dried residue to the initial mass, and is expressed in percent by weight.

The crosslinked polymer particles used also advantageously have a swelling index in toluene at 23° C. of less than about 80, more preferably of less than 60, more preferably still of less than 40. Accordingly, the swelling indices of the polymer particles (Qi) may with particular preference be between 1-20 and 1-10. The swelling index is calculated from the weight of the solvent-containing polymer particles swollen in toluene at 23° for 24 hours (after centrifugation at 20 000 rpm) and the weight of the dry polymer particles:

Qi=wet weight of polymer particles/dry weight of polymer particles.

To determine the swelling index, 250 mg of the polymer particles are subjected to swelling in 25 ml of toluene with shaking for 24 hours. The gel is recovered by centrifuging and weighed, and is subsequently dried to constant weight at 70° C. and weighed again.

The support membrane is preferably composed of an inorganic or organic material.

Furthermore, it is advantageous for the support membrane to be chemically and/or mechanically stable. It is to be pH-stable and also in organic solvents, such as, for example, aldehydes, ketones, monohydric and polyhydric alcohols, benzene derivatives, halogenated hydrocarbons, ethers, esters, carboxylic acids, cyclic hydrocarbons, amines, amides, lactams, lactones, sulphoxides, alkanes and alkenes.

It is preferred to select a support membrane which is chemically stable in the following solvents: acetone, toluene, benzene, water, tetrahydrofuran, dimethylformamide, dimethyl sulphoxide, N-methylpyrrolidone, N-ethylpyrrolidone, pyridine, methanol, ethanol, propanol, isopropanol, butanol, isobutanol, pentane, hexane, heptane, octane, nonane, decane, methyl ethyl ketone, diethyl ether, dichloromethane, tetrachloroethane, carbon tetrachloride, methyl tert-butyl ether, chlorobenzene, dichlorobenzene, trichlorobenzene, nitrobenzene, ethyl acetate, cyclohexane.

It has been found that the nanofiltration membrane of the invention is also stable in particular in the pH range of 10-14 and/or 1-4.

For the application of the membrane it is useful, furthermore, for the support membrane to he composed of a material which is temperature-stable both at room temperature and in typical application process temperatures. A temperature stability of 50 to 200° C., preferably between 70 and 150° C. and also 80 to 120° C., is also conceivable.

As inorganic, permeable support membrane it is possible for example to use non-woven glass microfibre fabrics, non-woven metal fabrics, dense woven glass-fibre fabrics or woven metal fabrics, but also woven or non-woven ceramic or carbon-fibre fabrics. To the skilled person it is clear that it is also possible here to use all other known, preferably flexible, materials that have open pores or openings of the corresponding size as support membranes. Ceramic composites can be used as well, such as inorganic support materials made of an oxide selected from Al₂O₃, titanium oxide, zirconium oxide or silicon oxide, for instance. The inorganic support membrane preferably also features a material selected from ceramic, SiC. Si₃N₄, carbon, glass, metal or semi-metal. It is possible, furthermore, for organic polymer materials which have a sufficient chemical and thermal stability to be used as support membrane, such as polyimide, polytetrafluoroethylene, polyvinylidene fluoride, polyetherimide, polyetherketone, polyetheretherketone, polyethersulphone, polybenzimidazole, polyamide.

The support membranes preferably have a pore size of less than 500 nm. With particular preference they have a pore size of less than 100 nm, and very preferably of less than 50 nm.

The pore size of the support membrane is with particular preference smaller than the average particle diameter of the polymer particles.

The thickness of the support membrane is preferably 5 to 100 μm, more preferably from 20 to 80 μm, very preferably from 30 to 60 μm.

The polymer particles which are prepared by emulsion polymerization are preferably at least partly functionalized by the addition of polyfunctional monomers in the polymerization. In this context, the polyfunctional monomers may be selected from the group consisting of the following: compounds having at least two, preferably 2 to 4, copolymerizable C═C double bonds, such as diisopropenylbenzene, divinylbenzene, divinyl ether, divinyl sulphone, diallyl phthalate, triallyl cyanurate, triallyl isocyanurate, 1,2-polybutadiene. N,N′-m-phenylenemaleimide, 2,4-tolylenebis(maleimide), triallyl trimellitate, acrylates and methacrylates of aliphatic amines, epoxides and polyhydric, preferably 2- to 4-hydric, C2 to C10 alcohols, such as ethylene glycol, propane-1,2-diol, butanediol, hexanediol, polyethylene glycol with 2 to 20, preferably 2 to 8, oxyethylene units, neopentyl glycol, bisphenol A, glycerol, trimethylolpropane, pentaerythritol, sorbitol and also unsaturated polyesters of aliphatic diols and polyols and maleic acid, fumaric acid, and/or itaconic acid.

The separation-active layer of the nanofiltration membrane of the invention preferably has at least one mono-layer of the polymer particles having the average particle diameter <70 nm, preferably between 30 to 65 nm, more preferably between 40 to 50 nm.

One preferred embodiment of the nanofiltration membrane of the invention has a separation-active layer with a thickness of 0.1 to 20 μm, where a plurality of layers of the polymer particles lie on top of one another.

The thickness of the separation-active layer is preferably not more than that of the support membrane.

A further invention is the production process for the nanofiltration membrane of the invention, in which a dispersion (latex) of polymer particles which are prepared by emulsion polymerization is applied to the support membrane, and a polymer layer (separation-active layer) is formed on the support membrane.

It has been ascertained that the dispersion used is very largely monodisperse, i.e., according to the method of dynamic light scattering, 95.4% of the polymer particles are present in a size class with a deviation of ±7 nm.

The process is preferably carried out continuously.

The aqueous dispersion preferably comprises polymer particles having average particle diameters <70 nm, preferably between 30 to 65 nm, more preferably between 40 to 50 nm, and the dry rubber content after the polymerization is at least 2096. preferably at least 25%, more preferably at least 30%, based on the total volume of the polymer.

Concentration of the latices to a dry rubber content of not more than 65%, based on the total volume of the polymer, is likewise conceivable for the production.

The dry rubber content is determined as follows: the dry rubber content is determined using a halogen moisture measuring instrument, such as the Mettler Toledo Halogen Moisture Analyzer HG63, for example. Here, a latex is dried at a temperature of 140° C. and subjected to continuous weighing. The measurement is considered to be at an end when the weight loss is less than 1 mg/50 sec.

The dry rubber content after the polymerization is preferably not more than 65%, based on the total volume of the polymer.

The latex with the polymer particles is preferably applied to the support membrane by means of a nozzle.

In a downstream step, the nanofiltration membrane formed in this way is dried. It is conceivable for the nanofiltration membrane thus formed to be additionally crosslinked, with the polymer particles being joined to one another and/or to the support membrane as a result. It is usual to employ chemical (covalent and/or ionic) and also physical crosslinking modes, initiated by electromagnetic (e.g. UV), thermal and/or radioactive radiation. All conventional crosslinking auxiliaries can he used.

As a result, the pore size is reduced still further and the filtration properties are modified.

A further invention is the use of polymer particles which are prepared by emulsion polymerization and which have average particle diameters <70 nm, preferably between 30 to 65 nm, more preferably between 40 to 50 nm, for producing a nanofiltration membrane.

Another invention is the use of the nanofiltration membrane for the food, chemical and biochemical industries. This listing is not limiting.

The invention is illustrated in more detail below, using examples.

### EXAMPLES

Preparation of Polymer Particles Types 1 and 2

The polymer particles were prepared using the following reactants. In Table 1, formula ingredients are based on 100 parts by weight of the monomer mixture.

Monomers
1) Butadiene (99% form, destabilized) from Lanxess Deutschland GmbH
2) Acrylonitrile (99% form, stabilized with hydroquinone monomethyl ether), from Merck KGaA
3) Styrene (98% form) from KMF Labor Chemie Handels GmbH
4) Trimethylolpropane trimethacrylate (96% form) from Aldrich; Product number: 24684-0; (abbreviation: TMPTMA)
5) Hydroxyethyl methacrylate (97% from Arcos; abbreviation: HEMA)

Emulsifiers
6) Disproportionated resin acid (abbreviated to RS)—calculated as free acid, starting from the amount used of Dresinate® 835 (Abieta Chemie GmbH; D-86358 Gersthofen)

The Dresinate® 835 batch used was characterized by its solids content and also by the emulsifier constituents present in the form of the sodium salt, the free acid, and neutral bodies.

The solids content was determined in accordance with the specification published by Maron, S. H.; Madow, B. P.; Borneman, E. “The effective equivalent weights of some rosin acids and soaps” Rubber Age, April 1952, 71-72.

The average value found for three aliquot samples of the Dresinate® 835 batch used was a solids content of 71% by weight.

The emulsifier fractions, present in the form of the sodium salt and the free acid, were determined by titrimetry in accordance with the method described by Maron, S. H., Ulevitch, I. N., Elder, M. E. “Fatty and Rosin Acids, Soaps, and Their Mixtures”, Analytical Chemistry, Vol. 21, 6, 691-695.

For the determination, (in one example) 1.213 g of Dresinate® 835 (71% form) were dissolved in a mixture of 200 g of distilled water and 200 g of distilled isopropanol, an excess of sodium hydroxide solution (5 ml of 0.5 N NaOH) was added, and back-titration took place with 0.5 N hydrochloric acid. The course of the titration was monitored by a potentiometric pH measurement. The titration curve was evaluated as described in Analytical Chemistry, Vol. 21, 6, 691-695.

The average value obtained on three aliquot samples of the Dresinate® 835 batch used was as follows:
Total emulsifier content: 2.70 mmol/g_{dry mass}
Na salt: 2.42 mmol/g_{dry mass}
Free acid: 0.28 mmol/_{dry mass}

With the aid of the molar masses for the Na salt of the disproportionated abietic acid (324 g/mol) and also the molar mass for the free disproportionated abietic acid (302 g/mol), the weight fractions of Na salt, free acid and uncaptured fractions of the Dresinate® 835 batch used were calculated:
Sodium salt of disproportionated resin acid: 78.4% by weight
Free disproportionated resin acid: 8.5% by weight
Uncaptured fractions (neutral bodies) 13.1% by weight

In the formulas below, the amounts of Dresinate® 835 used for the polymerizations were converted to free acid (abbreviated to RA) and expressed as weight fractions relative to 100 weight fractions of monomers. In this conversion, the neutral bodies were not taken into account.

To illustrate the conversion of the amounts of disproportionate abietic acid (RA) indicated in Table 1, on the basis of the amounts of Dresinate 835® used, Table 1 below is appended:

TABLE 1

| Initial mass of | Calculated amount of disproportionated |
|---|---|
| Dresinate ® 835 | abietic acid (without neutral bodies) |
| [g dry mass] | [g dry mass] |
| 0.25 | 0.20 |
| 0.5 | 0.41 |
| 1.0 | 0.82 |
| 1.5 | 1.22 |
| 2.0 | 1.63 |
| 2.5 | 2.04 |
| 3.0 | 2.45 |
| 3.5 | 2.86 |
| 4.0 | 3.26 |
| 4.5 | 3.67 |
| 4.75 | 3.87 |
| 5.0 | 4.08 |

⁷⁾ Partially hydrogenated tallow fatty acid-abbreviated to FA (Edenor ® HTiCT N from Cognis Oleo Chemicals)

The total emulsifier content and the average molecular weight of the Edenor® HTiCT N batch used was determined by titrimetry with the aid of the following methods: Maron, S. H., Ulevitch, I. N., Elder, M. E. “Fatty and Rosin Acids, Soaps, and Their Mixtures”, Analytical Chemistry, Vol. 21, 6, 691-695; Maron, S. H.; Marlow, B. P.; Borneman, E. “The effective equivalent weights of some rosin acids and soaps” Rubber Age (1952), 71 71-2). In the titration, (in one example) 1.5 g of Edenor® HTiCT N was dissolved in a mixture of 200 g of distilled water and 200 g of distilled isopropanol, an excess of 15 ml of NaOH (0.5 mol/l) was added, and back-titration took place with 0.5 M hydrochloric acid.

In this case, the average value found for three aliquot portions of the Edenor® HTiCT N batch used was as follows:
Total emulsifier content: 3.637 mmol/g_{dry mass}
Molar mass (free acid): 274.8 mg/mmol

In the formulas below, the amounts of partially hydrogenated tallow fatty acid used (as available commercially) were expressed as “free acid=FA”.

The amounts needed for setting the degrees of neutralization reported in the tables were calculated on the basis of the amounts, determined by titrimetry, of the various constituents of the Dresinate® 835 and Edenor® HTiCT N batches used. The degrees of neutralization were set using potassium hydroxide.

Chain-Transfer Regulator
8) tert-Dodecyl mercaptan from Chevron Phillips Chemical Company LP (Sulfole® 120)

The polymer particles were prepared by emulsion polymerization in a 20 1 autoclave with stirrer. For the polymerization batches, 4.3 kg of monomers with 0.34 g of 4-methoxyphenol (Arcos Organics, Article No. 126001000, 99%) were used. The total emulsifier amounts and total water amounts reported in the table (with subtraction of the amounts of water required for preparing the aqueous premix solutions and p-menthane hydroperoxide solutions—see below) were introduced into the autoclave in each case, together with the emulsifiers and the amounts of potassium hydroxide required.

After conditioning of the reaction mixture at 15° C., 50% freshly prepared aqueous premix solutions (4% strength) were introduced into the autoclave for each of the polymerization batches listed. These premix solutions consisted of:

| | |
|---|---|
| 0.284 g | ethylenediaminetetraacetic acid (Fluka, Article number 03620), |
| 0.238 g | iron(II) sulphate * 7 H₂O (Riedel de Haen, Article number: 12354) |
| | (calculated without water of crystallization) |
| 0.576 g | Rongalit C, Na formaldehyde sulphoxylate 2-hydrate |
| | (Merck-Schuchardt, Article number 8.06455) |
| | (calculated without water of crystallization) and |
| 0.874 g | trisodium phosphate * 12 H₂O (Acros, Article number 206520010) |
| | (calculated without water of crystallization). |

For the activation of the listed polymerizations, 5 g for the styrene-containing type and 1.7 g for the acrylonitrile-containing type were used of p-menthane hydroperoxide (Trigonox NT 50 from Akzo-Degussa), and were emulsified in 200 ml of the emulsifier solution prepared in the reactor. When a conversion of 30% was reached, the remaining 50% of the premix solution was metered in.

The temperature regime during the polymerization was guided by setting amount of coolant and temperature of coolant, within the temperature ranges indicated in the tables.

When a polymerization conversion of more than 85% was reached (typically: 90% to 100%), the polymerization was halted by addition of an aqueous solution of 2.35 g of diethylhydroxylamine (DEHA, Aldrich, Article number 03620).

Removal of Volatile Constituents

Volatile constituents were removed from the latex by subjecting it to a steam distillation under atmospheric pressure.

The polymer particles prepared in this way are used for a nanofiltration membrane of the invention.

Table 2 shows the formula of the polymer particles prepared; the indices used are as follows:
1) Butadiene (unstabilized)
2) Acrylonitrile (99% form, stabilized with hydroquinone monomethyl ether), from Merck KGaA
3) Styrene (stabilized with 100 to 150 ppm of 4-tert-butylpyrocatechol)
4) Trimethylolpropane trimethacrylate (96% form from Aldrich)
5) Hydroxyethyl methacrylate (97% form from Arcos)
6) Amount of disproportionated resin acid (abbreviated to RA), calculated from the amount of Dresinates 835 used
7) Edenor HTiCT N from Oleo Chemicals (abbreviated to FA)
8) tert-Dodecyl mercaptan (Sulfol® 120 from Chevron Phillips)

The properties of the particles prepared are shown in Table 3.

TABLE 2

| | | | | | | | | Emulsifiers [phm] | | | | | Poly- | | |
|---|---|---|---|---|---|---|---|---|---|---|---|---|---|---|---|
| | | | | | | | | | | | Degree | | mer- | Poly- | |
| Poly- | | Monomers | | | | | | | | | of | | ization | mer- | |
| mer | | [parts by weight] | | | | | | | | | neu- | | Tem- | iza- | Con- |
| par- | tert- | | | Acry- | | | | | | | trali- | | per- | tion | ver- |
| ticle | DDM | Buta- | | loni- | | | | | | RA + | zation | Water | ature | time | sion |
| type | [phm]⁸⁾ | diene¹⁾ | Styrene²⁾ | trile³⁾ | TMPTMA⁴⁾ | HEMA⁵⁾ | RA⁶⁾ | FA⁷⁾ | RA/FA | FA | [%] | [phm] | [° C.] | [min] | [%] |
| 1 | 0.45 | 58 | — | 38 | 4 | — | 3.67 | 0.44 | 8.34 | 4.11 | 123 | 300 | 15-20 | 340 | 98 |
| 2 | 0.45 | 10.5 | 80.5 | — | 4 | 7.5 | 3.67 | 0.44 | 8.34 | 4.11 | 123 | 300 | 15-20 | 300 | 95 |

TABLE 3

| | Solids content | Latex pH | | | | | | |
|---|---|---|---|---|---|---|---|---|
| Polymer | (after monomer | (after | Gel | | Add | OH | | Particle |
| particle | removal) | monomer | content | Swelling | number | Number | Tg | diameter |
| type | [% by weight) | removal) | [% by weight] | index | [mg KOH/g microgel] | | [° C.] | [nm] |
| 1 | 28.8 | 7.8 | 98 | 5.1 | — | — | −16 | 65 |
| 2 | 28.3 | 7.5 | 96 | 11.3 | 7.5 | 20.0 | 62 | 47 |

Production of the Inventive Nanofiltration Membrane with Polymer Particle Type 1 and with Polymer Particle Type 2

The support membrane used was highly crosslinked polyimide. This membrane was coated by the bead-coating process, using a slot die, with an aqueous dispersion of rubber-like polymer particles of type 1 or 2. The support membrane was conveyed beneath the die at a speed of 2 m/min. The distance of the die from the support membrane was 100 μm. The wet-film thickness of the latex layer was estimated at 30 μm, giving a dry-film thickness for the separation-active layer of approximately 10 μm. Drying took place at room temperature under atmospheric pressure for about 30 minutes. Nanofiltration membrane type 1 (with type-1 polymer particles) and nanofiltration type 2 (with type-2 polymer particles) were produced.

In the case of inventive nanofiltration membrane type 2, the crosslinking of the polymer particles was carried out additionally after drying. The crosslinking agent used was 1,6-hexamethylene diisocyanate (HDI). First of all, the membrane was washed with acetone and then with n-hexane. Then a solution of 2% by weight of HD1 and 0.2% by weight of dioctyltin laurate in n-hexane was applied to the membrane. After a reaction time of 20 minutes at 25° C., the reaction solution was removed and the membrane was washed with acetone.

Determination of Filtration Properties

The filtration properties of the inventive nanofiltration membranes were measured with a model system of polystyrene oligomers in various solvents. The oligomers had molecular weights of between about 230 and 1100 g/mol. Following the passage of a sufficiently large amount of permeate, samples were taken of retentate and permeate and the respective concentration of the oligomers was determined chromatographically by HPLC. From the resultant concentrations of each of the oligomers it is possible to determine their retention by the membrane and hence the molecular weight cut-off.

Filtration Properties of Inventive Nanofiltration Membrane Type 1

Table 4 shows the values for the retention of polystyrene oligomers by an inventive nanofiltration membrane type 1, with the separation-active layer being composed of type-1 polymer particles which had not been additionally crosslinked. The solvent selected was acetone. Separation of the styrene oligomers took place at 25° C. under a pressure of 30 bar. The flow rate was determined as being 11 l/m (m² h).

TABLE 4

| Molecular | Retention/ |
|---|---|
| weight/g/mol | % |
| 236 | 21 |
| 295 | 38 |
| 395 | 56 |
| 495 | 67 |
| 595 | 74 |
| 685 | 81 |
| 795 | 83 |
| 895 | 87 |
| 995 | 90 |

In the test system defined here, therefore, the nanofiltration membrane of the invention has a cut-off of approximately 1000 g/mol, since the retention measured here was 90%. The membrane is therefore suitable for nanofiltration.

Filtration Properties of Inventive Nanofiltration Membrane Type 2

Table 5 contains values for the retention of polystyrene oligomers by an inventive nanofiltration membrane type 2, with the separation-active layer being composed of type-2 polymer particles which had been additionally crosslinked by 1,6-hexamethylene diisocyanate. The values are reported for filtration in three different solvents (acetone, tetrahydrofuran (THF) and toluene). Flow rates of 7 to 11 l/(m² h) were measured at a temperature of 25° C. and a pressure of 30 bar.

TABLE 5

| Molecular | Solvent: toluene | Solvent: THF | Solvent: acetone |
|---|---|---|---|
| weight/g/mol | retention/% | retention/% | Retention/% |
| 236 | — | 42 | 34 |
| 295 | 52 | 50 | 45 |
| 395 | 73 | 71 | 66 |
| 495 | 82 | 79 | 76 |
| 595 | 88 | 85 | 84 |
| 695 | 91 | 87 | 87 |
| 795 | 93 | 89 | 89 |
| 895 | 95 | 89 | 91 |
| 995 | 96 | 90 | 92 |
| 1095 | 96 | 91 | 93 |

From the measurement values shown here it is evident that, after crosslinking of the polymer particles, the cut-off of this membrane is situated at 700 to 800 g/mol, meaning that the membrane can be used for nanofiltration. The figures are dependent only to a slight extent on the solvent selected. In all of the solvents used, the inventive membranes did not show any signs of dissolution.

What is claimed is:

1. Nanofiltration membrane having a porous support membrane, characterized in that the surface of the support membrane is coated with polymer particles which are prepared by emulsion polymerization and have an average particle diameter of less than 70 nm, preferably between 30-65 nm, more preferably between 40-50 nm.

2. Nanofiltration membrane according to claim 1, characterized in that the support membrane is composed of an inorganic or organic material.

3. Nanofiltration membrane according to claim 2, characterized in that the pore size of the support membrane is less than 500 nm, preferably less than 100 nm and more preferably less than 50 nm.

4. Nanofiltration membrane according to claim 3, characterized in that the pore size of the support membrane is smaller than the average particle diameter of the polymer particles.

5. Nanofiltration membrane according to claim 4, characterized in that the thickness of the support membrane is 5 to 100 μm, preferably 20 to 80 μm and very preferably from 30 μm to 60 μm.

6. Nanofiltration membrane according to claim 5, characterized in that the polymer particles which are prepared by emulsion polymerization are rubber-like.

7. Nanofiltration membrane according to claim 6, characterized in that the rubber-like polymer particles are particles based on conjugated dienes such as butadiene, isoprene, 2-chlorobutadiene and 2,3-dichlorohutadiene, vinyl acetate, styrene or derivatives thereof, 2-vinylpyridine and 4-vinylpyridine, acrylonitrile, acrylamides, methacrylamides, tetrafluoroethylene, vinylidene fluoride, hexafluoropropene, and double-bond-containing hydroxyl, epoxy, amino, carboxyl and keto compounds.

8. Nanofiltration membrane according to claim 7, characterized in that the polymer particles have a glass transition temperature (Tg) of −85° C. to 150° C., preferably −75° C. to 110° C., more preferably −70° C. to 90° C.

9. Nanofiltration membrane according to claim 8, characterized in that the polymer particles which are prepared by emulsion polymerization are at least partly crosslinked.

10. Nanofiltration membrane according to claim 9, characterized in that the polymer particles which are prepared by emulsion polymerization are at least partly functionalized by the addition of polyfunctional monomers in the polymerization.

11. Nanofiltration membrane according to claim 10, characterized in that the polyfunctional monomers are selected from the group consisting of the following: compounds having at least two, preferably 2 to 4, copolymerizable C═C double bonds, such as diisopropenylbenzene, divinylbenzene, divinyl ether, divinyl sulphone, diallyl phthalate, triallyl cyanurate, triallyl isocyanurate, 1,2-polybutadiene, N,N′-m-phenylenemaleimide, 2,4-tolylenebis(maleimide), triallyl trimellitate, acrylates and methacrylates of aliphatic amines, epoxides and polyhydric, preferably 2- to 4-hydric, C2 to C10 alcohols, such as ethylene glycol, propane-1,2-diol, butanediol, hexanediol, polyethylene glycol with 2 to 20, preferably 2 to 8, oxyethylene units, neopentyl glycol, bisphenol A. glycerol, trimethylolpropane, pentaerythritol, sorbitol and also unsaturated polyesters of aliphatic diols and polyols and maleic acid, fumaric acid, and/or itaconic acid.

12. Nanofiltration membrane according to claim 11, characterized in that the polymer particles have an approximately spherical geometry.

13. Nanofiltration membrane according to claim 12, characterized in that the polymer particles have fractions insoluble in toluene at 23° C. of at least about 70% by weight, preferably at least about 80%, more preferably 90% by weight, even more preferably at least about 98% by weight.

14. Nanofiltration membrane according to claim 13, characterized in that the polymer particles in toluene at 23° C. have a swelling index of less than about 80, preferably 60 and more preferably 40.

15. Nanofiltration membrane according to claim 14, characterized in that the layer thickness of the nanofiltration membrane has at least one monolayer of the polymer particles having the average particle diameter of less than 70 nm, preferably 30-65 nm, more preferably 40-50 nm (separation-active layer).

16. Nanofiltration membrane according to claim 15, characterized in that the separation-active layer has a layer thickness of 0.1 μm to 20 μm.

17. Nanofiltration membrane according to claim 16, characterized in that the separation-active layer has a thickness not more than the thickness of the support membrane.

18. Process for producing a nanofiltration membrane having a porous support membrane according to any of the preceding claims, characterized in that a dispersion (latex) of polymer particles which are prepared by emulsion polymerization is applied to the support membrane, and a polymer layer (separation-active layer) is formed on the support membrane.

19. Process according to claim 18, characterized in that the process is carried out continuously.

20. Process according to claim 19, characterized in that the dispersion is monodisperse.

21. Process according to claim 20, characterized in that the dispersion has polymer particles with an average particle diameter of less than 70 nm, preferably 30-60 nm, more preferably 40-50 nm, the dry rubber content after the polymerization being at least 20%, preferably at least 25%, more preferably at least 30%, based on the total volume of the polymer.

22. Process according to claim 21, characterized in that the dry rubber content after the polymerization is not more than 65%, based on the total volume of the polymer.

23. Process according to claim 22, characterized in that the polymer particles are applied by means of a nozzle.

24. Process according to claim 23, characterized in that the nanofiltration membrane is dried in a downstream step.

25. Process according to claim 24, characterized in that the separation-active layer of the nanofiltration membrane is additionally crosslinked.

26. Use of polymer particles which are prepared by emulsion polymerization and have an average particle diameter of less than 70 nm, preferably 30-60 nm, more preferably 40-50 nm for producing a nanofiltration membrane according to any of the preceding claims.

27. Use of the nanofiltration membrane according to any of the preceding claims for the food, chemical or biochemical industry.
